(19) United States
(12) Patent Application Publication
(10) Pub. No.: US 2011/0153425 A1
(43) Pub. Date: Jun. 23, 2011

(54) KNOWLEDGE BASED SEARCH ENGINE

(76) Inventor: James Mercs, Huntington Beach, CA (US)

(21) Appl. No.: 12/819,974

(22) Filed: Jun. 21, 2010

Related U.S. Application Data
(60) Provisional application No. 61/218,973, filed on Jun. 21, 2009.

(51) Int. Cl. G06Q 30/00; G06F 17/30

(52) U.S. Cl. 705/14.54; 707/706; 707/E17.108

(57) ABSTRACT

A system and method for searching a network such as the Internet based in part on relationships in a social network is described. Descriptive data and searching parameters associated with various users is collected and stored such that users can group themselves based on the descriptive data. Information that is deemed by users to be relevant to a particular group is collected and organized in a database to be used in information gathering for future searches by the users, in addition to other resources, such as other search engines. Through the system and method for searching a network, a group of users decide what information is highly relevant content information for the group. The system also allows a user to rank resources from which to gather information.

### CROSS-REFERENCE TO RELATED APPLICATIONS

The present application claims priority from provisional application Ser. No. 61/218,973, filed Jun. 21, 2009, entitled Critter Knowledge Based Search Engine.

### FIELD OF THE INVENTION

The present invention relates generally to internet searching, and in particular, to methods and systems for performing internet searches based on user-defined criteria.

### BACKGROUND OF THE INVENTION

The Intenet is a global system of interconnected computer networks that use the standard Internet Protocol Suite (TCP/IP) to serve billions of users worldwide. It carries a vast array of documents, files, databases, text collections, audio clips, video clips and many other types of information.

Search engines are designed to search for information on the Internet. A user typically enters a query into a search engine in response to which the search engine provides a list of results. A problem with typical search engines is that the results are overly comprehensive and many of the results are irrelevant to what the particular user intended to search for. A user must often sift through a large amount of irrelevant results in order to find information pertaining to the user's need.

It would be beneficial to provide a method for searching the Internet or World Wide Web that can provide results that are more germane to a user's particular informational need. A user is given higher contextual results based on a combination of other previous searches that were tagged as “high value” by the user or by groups of which the user is a member. A user may have many groups he or she are associated with, (i.e., Friends group, Departments at work group, Social Clubs group, Family group, etc.).

### SUMMARY

A software mechanism is provided that links users in way so that they can search the Internet as groups. Through the mechanism, a group decides what information is highly relevant content information for the group. Similar to the human brain, the mechanism remembers results from previous user or group searches that were deemed to be highly relevant and relies on them for relevancy for future searches. A database stores the relevant user or group search results, and when a user from the group performs a search, the mechanism searches the database in addition to other resources, such as other search engines. The user can also select the weight to be given to the resources the mechanism uses, such that only a percentage of the results returned by the mechanism will be from the group database, while the remainder of the results will be from other resources.

For example, a user can define a group based on friends, common interests with other users, or location, among other things. Thus, as users in a particular group search the Internet and find what they consider to be highly relevant content for that group, such as a website or other link, the mechanism can store that content in a group specific database. Then, in the future, when another user from the group performs a search, he or she can choose to influence the search such that results from the group database are ranked higher than other search results, which will lead to more highly relevant search results over all.

Furthermore, the mechanism allows users to select filters related to Internet navigation to further influence their Internet searches and lead to more relevant search results. For example, a user can specify particular interests within certain categories that will then be factored into any searches. A user's search can also be filtered based on the user's location. For example, if a user utilizes the mechanism via a mobile device, results can be based on the mobile devices geographical location. A user can also define the duration of searches, meaning a rate at which the mechanism finds data and how long it will have to update information if it finds something new. The user can also limit interruptions by predefinition when the application allows interruptions from email, searches and other applications. In addition, the a filter can be set to only allow certain email, searches, advertisements, and applications within a user defined time period. The mechanism also allows a user to integrate weighted information from other search engines into the mix of an overall search by the mechanism.

The mechanism also allows users to identify their interests to certain advertisers and business groups and receive information directly from those entities. This leads to higher relevant ad placement for advertisers and less irrelevant ads sent to the user.

These and other features of the present invention will be discussed in more detail below.

### BRIEF DESCRIPTION OF THE DRAWINGS

FIG. 1 is a system diagram of one embodiment of an environment in which the invention may be practiced;

FIG. 2 is a flowchart illustrating a process of a sample search;

FIG. 3 is a flowchart illustrating a process of a sample search;

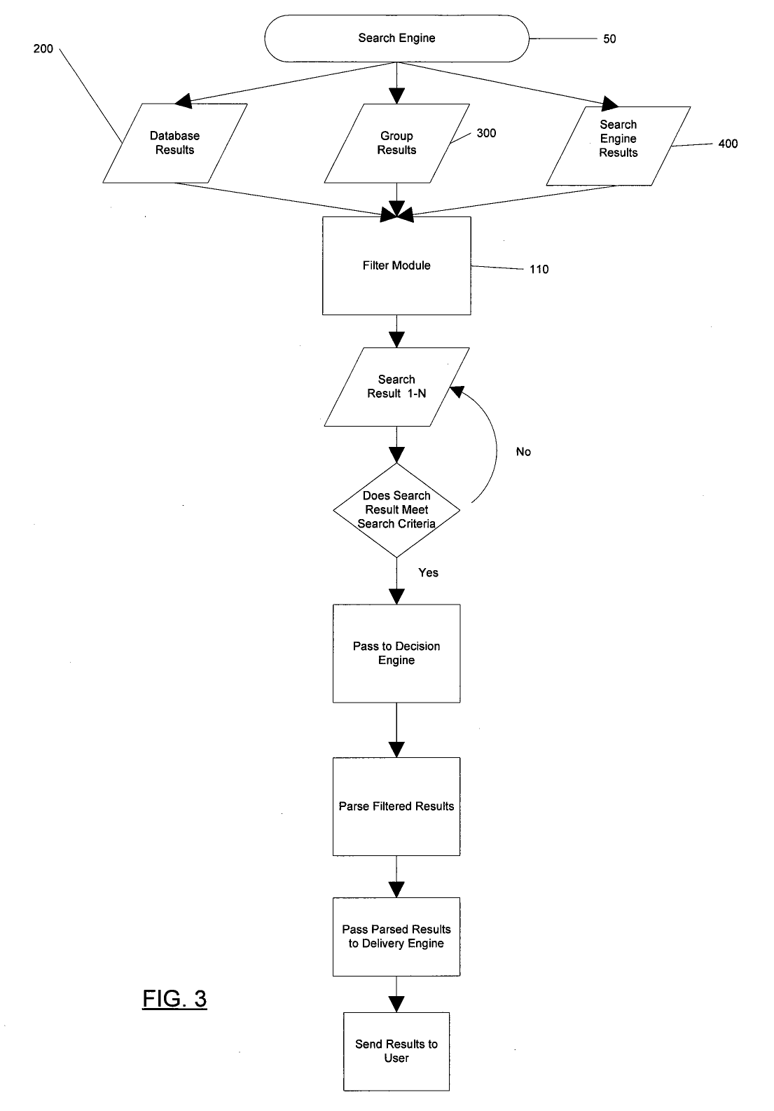

FIG. 4 is a flowchart illustrating a process of a sample search;

FIG. 5 is a flowchart illustrating a process of a sample search;

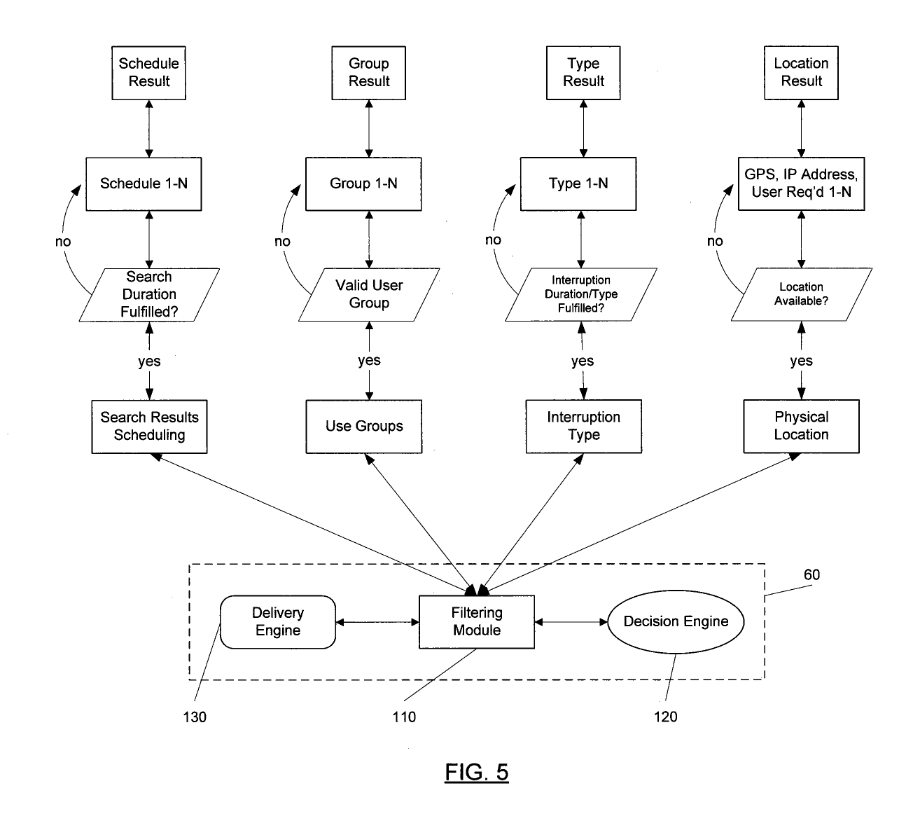

FIG. 6 illustrates a sample webpage;

FIG. 7 illustrates a sample webpage;

FIG. 8 illustrates a sample webpage;

FIG. 9 illustrates a sample webpage.

### DETAILED DESCRIPTION

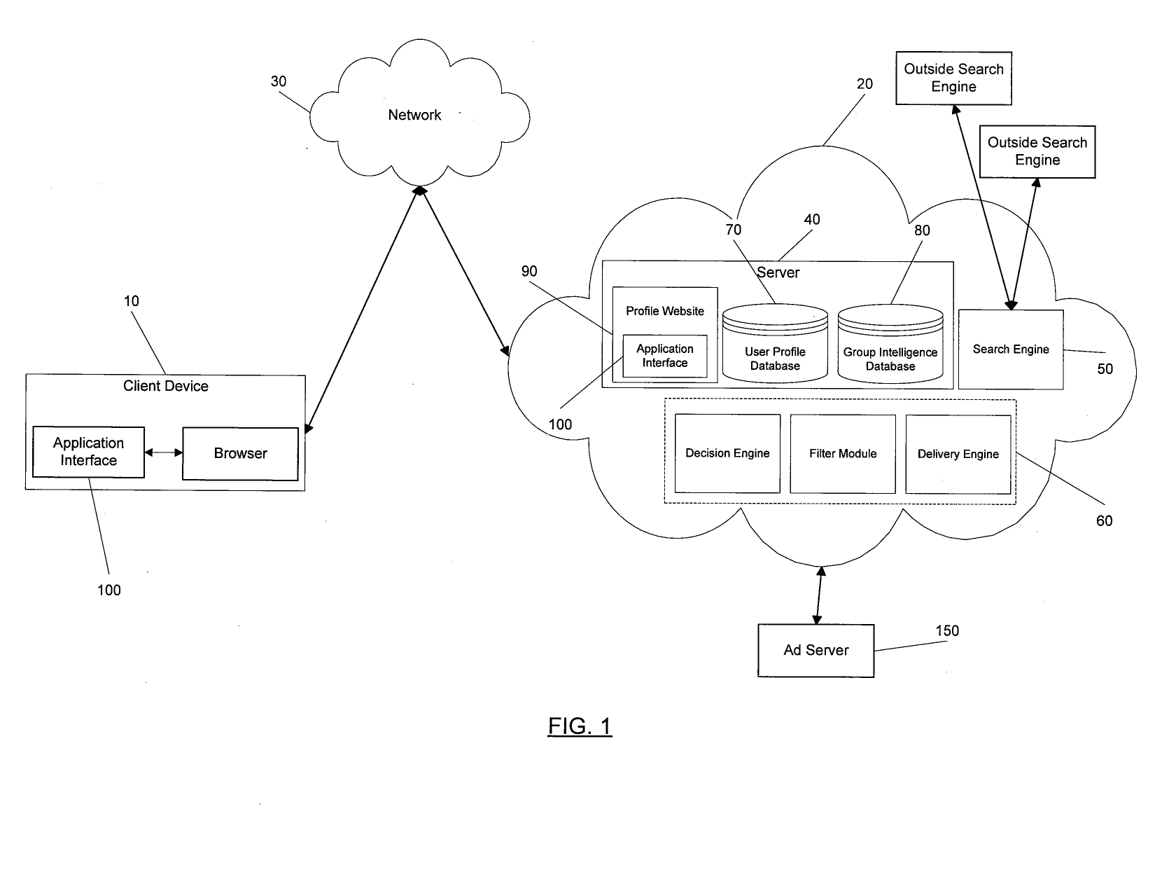

FIG. 1 is a high-level schematic illustration of an exemplary system architecture in accordance with an embodiment of the present invention. In this system architecture, there is a client device 10, that interacts with a cloud application 20 over a network 30 (e.g. Internet, telephony, LAN, WAN, or combination thereof). Cloud application 20 can comprise a pool of virtualized resources on a network, such as the Internet, that communicate with each other, as well as other sites, servers, locations, and resources available through the Internet or other public or private networks, whether within a given cloud or between clouds, through a standard open application programming interface (API), or through other calls or interfaces to act together as a virtual machine to perform a desired process for a limited or defined duration. Because the resources that combined in the cloud application 20 are all hosted remotely in the cloud, a standard browser interface can be used to access the cloud from a client device 10, and the resources need not depend on or require the user's own on-premise hardware or other resources.

The client device 10 can be any type of client such as a desktop computer, laptop computer, mobile telephone, smart phone, email device, television, cable and/or satellite set-top box, game console, personal digital assistant, media player, or the like. The client device 10 need only have the capability to communicate over the network with the cloud application 20. Typically, a client device 10 will support a browser application, and the appropriate networking applications and components, all of which are known to those of skill in the art. The user of the client device 10 transmits a search query to the cloud application 20 via the network 30. The client device 10 may include an application interface 100 that allows it to directly query the cloud application 20. A single user may have multiple client devices 10 each including an application interface 100 that interacts with the cloud application 20. Alternatively, the interface can be a search query field on a profile website 90. An application interface 100 residing on a client device 10 may also act as a portal to profile website 90.

The cloud application 20 may also include a server 40, a search engine 50 and a search processor 60. Server 40 is configured to host the profile website 90, as well as include at least a user profile database 70 and a group intelligence database 80. These databases are not exhaustive, and it is understood that any number of databases may be used with the system.

The search engine 50 is configured to search the user profile database 70 to obtain a set of database results 200 that are responsive to a user's search query. The search engine 50 is also configured to search the group intelligence database 80 to obtain a set of group results 300 that are responsive to a user's query. The search engine 50 is also configured to search data responsive to a user's query that is accessible via the network either on its own or by directing other search engines, such as Google or Bing, to perform the requested searches to obtain a set of search engine results 400 responsive to a user's search query based on the other search engines' standard searching protocol and retrieve those search engine results 400. The search engine 50 then aggregates all the search results, 200, 300 and 400, and transmits them to the search processor 60 where the search criteria is processed.

Search processor 60 includes a filter module 110 configured to analyze certain user defined parameters and match search results to those parameters, a decision engine 120 configured to parse data from various resources, including data retrieved by the search engine 50, based on a user's predefined rankings, and a delivery engine 130 configured to send data to a user.

Filter module 110 is configured to receive the search results from search engine 50 and identify search results that match the search criteria provided by a user. In an embodiment, filter module 110 also identifies user specific data related to the search results in order to identify common interests among users. When common interests are identified, the server 40 allows multiple users' application interfaces 100 to negotiate with one another and allow the user's to interact with one another.

Search results provided by search engine 50 are then passed to decision engine 120. The decision engine 120 parses the search results based on the data sources from which they came and orders them according to the user's predefined ranking.

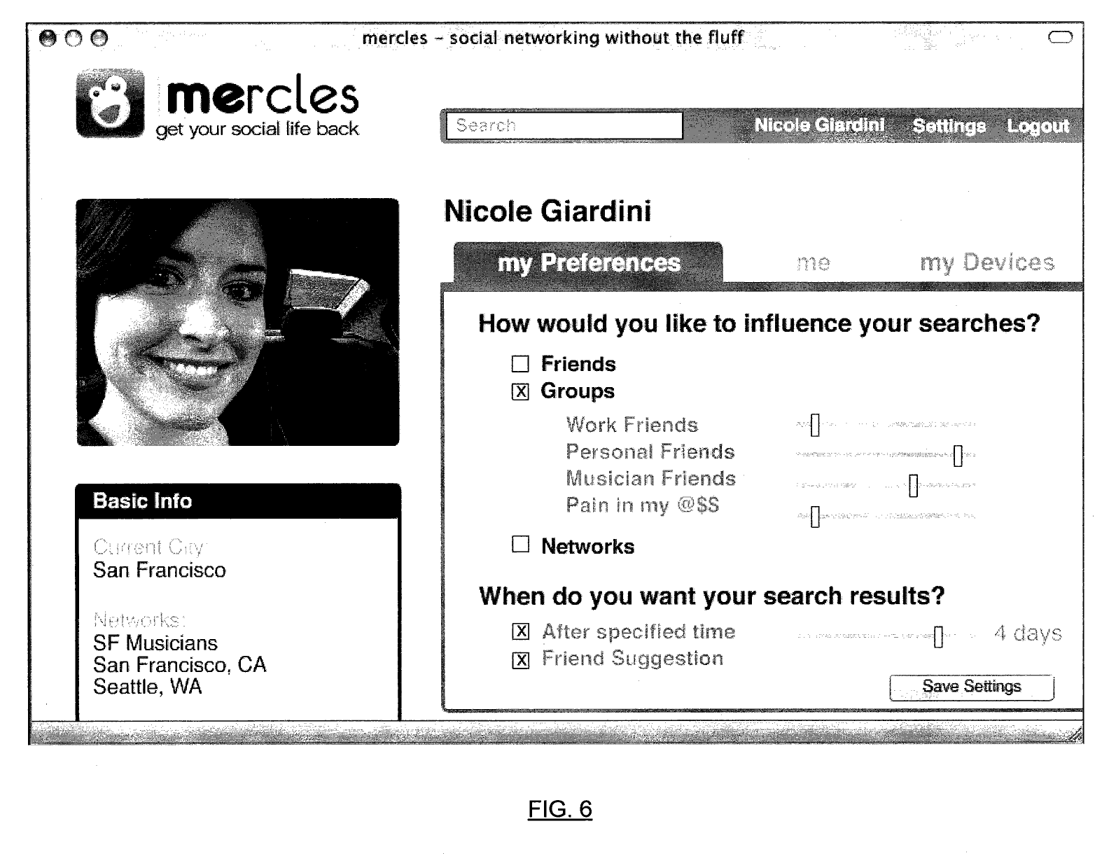

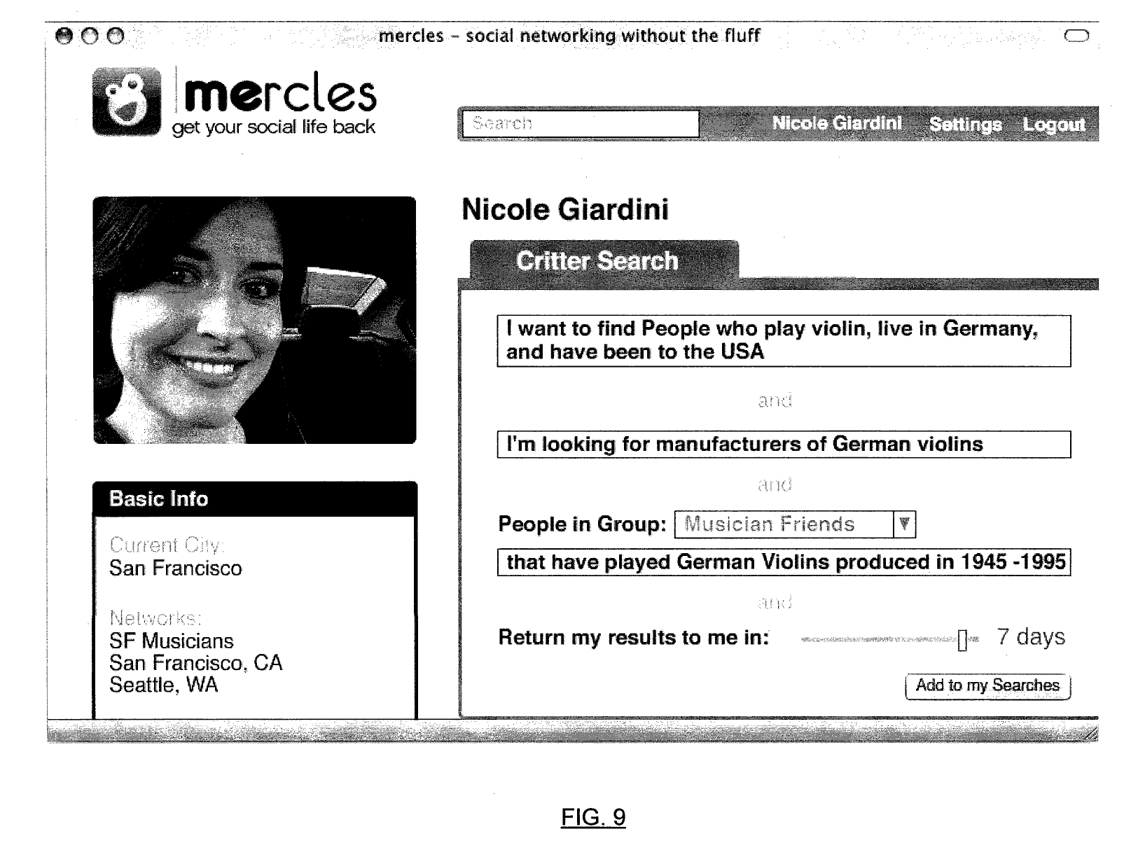

In use, a user begins by accessing profile website 90 using the standard Internet Protocols. Profile website 90 is configured like a social networking website allowing a user to identify Friends, join Groups based on common interests and identify other social networks to which the user belongs. The user can also identify his or her interests via the profile website 90 and opt to allow other users, as well as advertisers to access his or her interests. The user can also manage the application interfaces 100 that reside on one or more of the user's client devices 10. All of this information is used to form a user profile that is then stored in the user profile database 70. FIGS. 6-9, show screenshots of web pages of an exemplary website 90. In FIG. 6, a screen is shown that collects preference criteria related to a user's search preferences. For example, a user can choose to have his or her searches influenced by Groups as well as have searches returned from outside search engines like Google or Bing. The user ranks how he or she wants the search to be influenced, for example, 60% Groups, 20% Google, 20% Bing, and then for each search performed, the results will be broken down and identified according to the selected ratios, such that 60% of the returned results will be relevant database results 200 and group results 300 that were deemed relevant by the group. It also can be limited to only groups, for example, 30% Family group, 30% Truck Owners group, and 40% Work group.

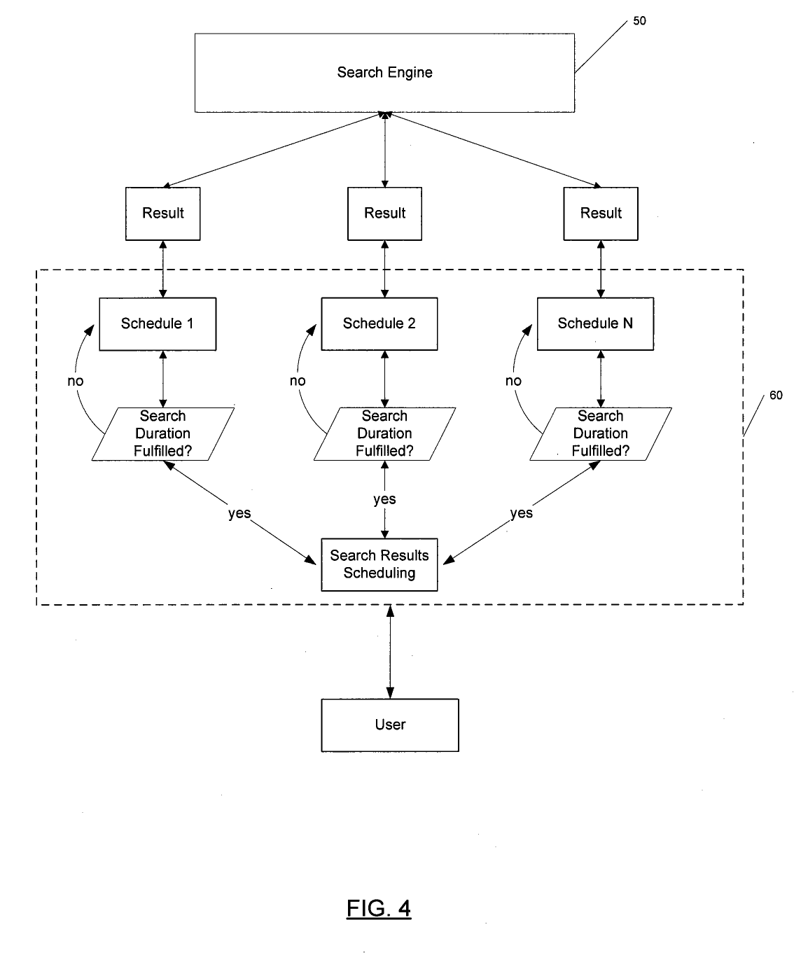

Furthermore, a user can define the time limits of a search and when the search should be completed. The user can ask for the search results to be returned immediately or within a week. If the user requests a one week return time, the search engine 50 will continually search resources and update the results with the most recent data until the search criteria processor 60 returns the results to the user, as exemplified in FIG. 4.

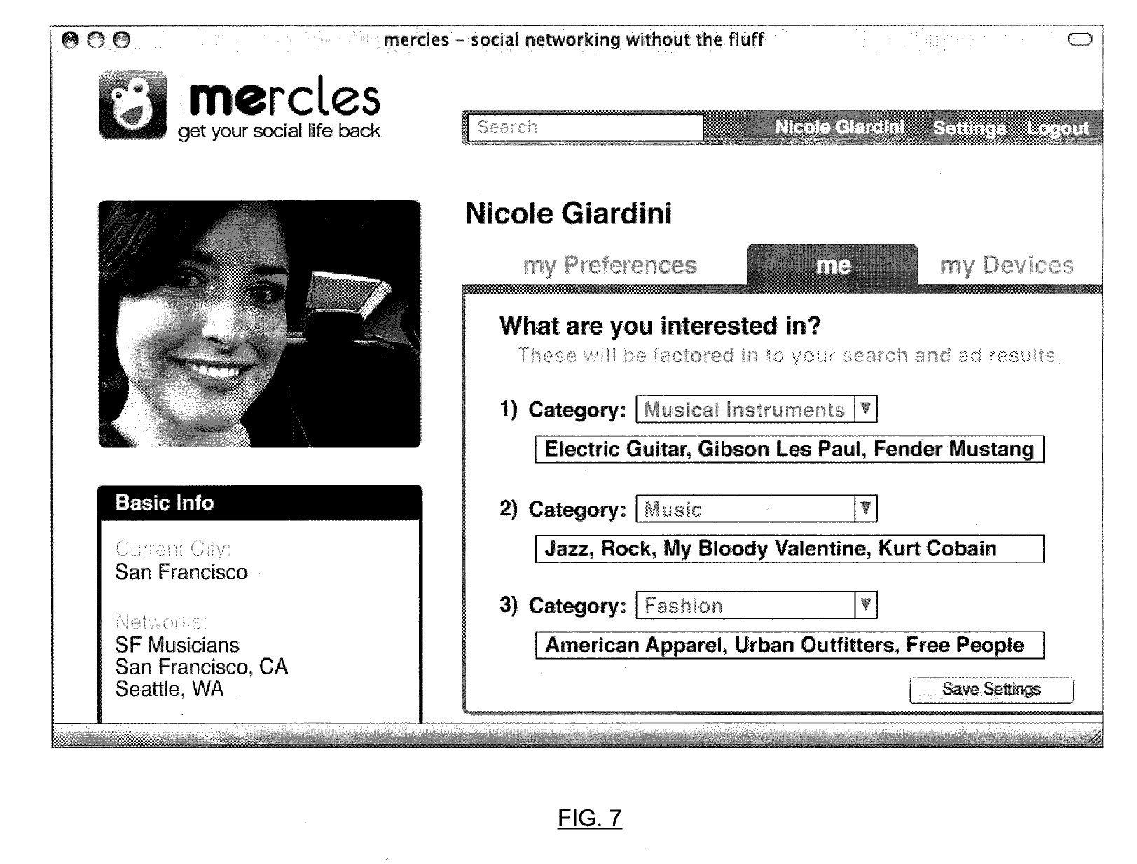

In FIG. 7, a screen is shown that collects descriptive data related to the user's particular interests. For instance, lists of categories may be provided that a user can select and enter related information relevant to the user's likes and dislikes within that category, which is then stored in the user profile database 70. In an embodiment, user information stored in user profile database 70 includes, but is not limited to, the user's interests and hobbies, the user's social networking information, such as MySpace, Facebook, or LinkedIn, membership groups to which the user belongs, and the user's location information.

In an embodiment, social networking information may be obtained once a user has provided account access to the user's social network accounts. Cloud application 20 communicates with other social networking applications, such as, Facebook, LinkedIn, and MySpace, and pulls data from each through an open API framework, and server 40 assembles the data and stores it in the user profile database 70. A user can opt to identify these interests to friends, other users, and advertisers. Thus, when the user requests a search, the search engine 50 will factor this descriptive data into its search of the user profile database to identify other users who share common interests and negotiate with the search criteria processor to determine if that other user has granted the search engine permission to access that user's group intelligent database submissions.

In an embodiment, user location information is based both on a user's actual geographical location as determined by GPS, as well as on a user's physical residence(s), locations of interests, as well as search on IP addressable regions, the user has implicitly or explicitly shared with the system, or the like, may also be stored within user profile database 70. Such information may indicate that the user resides in a particular town, neighborhood, city, or the like, within a particular county, state, country, or the like, or is interested in a given location (e.g. venue, district, city, region, etc.), or the like.

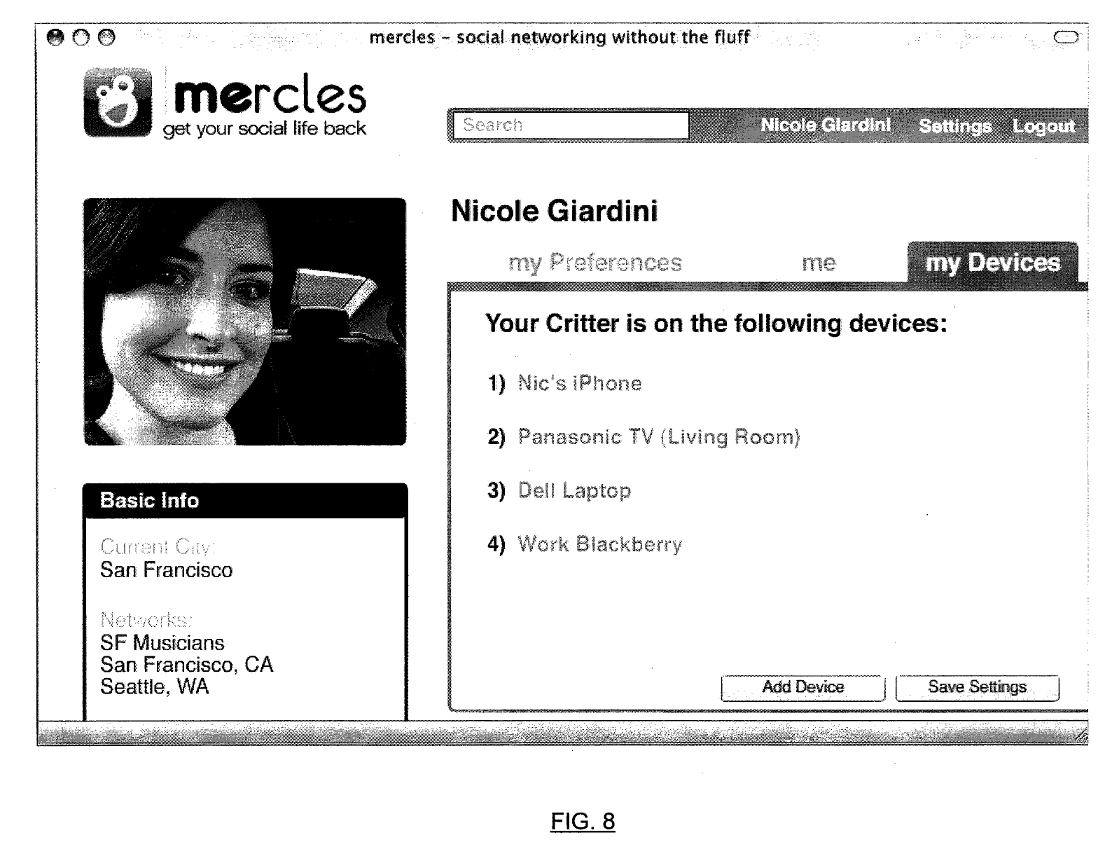

In FIG. 8, a screen is shown that collects data about the user's client devices 10. As mentioned above, the application interface 100 can reside on multiple client devices 10. Via the profile website 90, a user can manage his or her client devices on which an application interface 100 resides. The server 30 recognizes the application interfaces 100 associated with each client device 10 owned by one user. The main data associated with user preferences and search is kept in the cloud application 20. The critter application is simply for data entry from devices and a way for critters to communicate and discover other critter applications. Think of them as your representative traveling through cyber space.

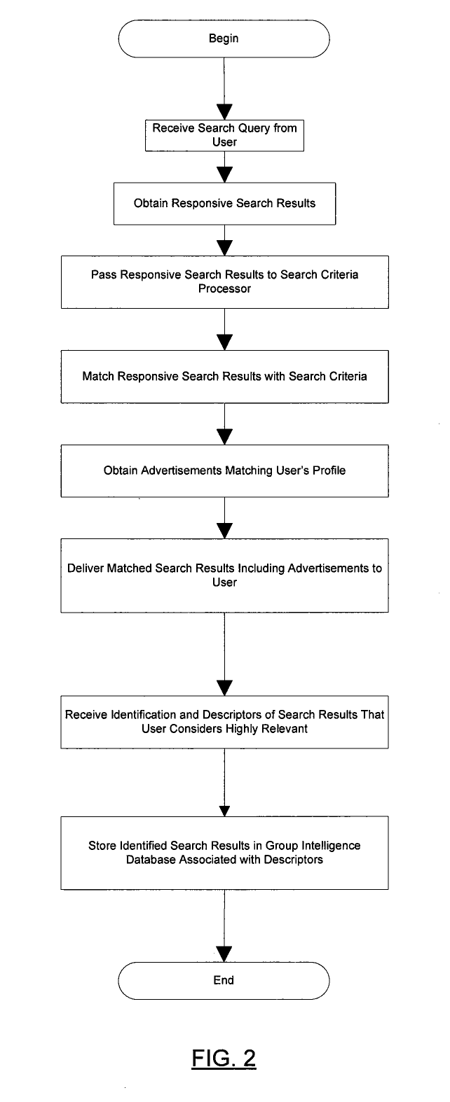

In use, a user installs application interfaces 100 on one or more client devices that allow the user to connect to the profile website 90, submit a search query and recommend highly relevant search results. A user can submit a search query via the application interface 100 on a client device or via the profile website. Once a user enters the search query, the search engine 50 obtains search results 200, 300 and 400 responsive to the query and passes the results 200, 300 and 400 to the search criteria processor 60. In the search criteria processor 60, the filter module 110 analyzes the search results 200, 300 and 400 and identifies search results 200, 300 and 400 that match criteria defined in the user's profile, exemplified in FIG. 2.

Furthermore, the search engine 50 will communicate with an ad server 150 to determine if the ad server has any relevant advertisements in its database that match the users descriptive data, and then determine what the user's preferences are related to receiving advertisements and allow relevant advertisements that match the user's advertisement criteria.

The filtered search results including any matching advertisements are returned to the user. The user may choose to then choose to identify certain of the results as highly relevant in relation to the search query via the application interface 100. As a non-limiting example, a user may select a search result or any online web page or resource. In an embodiment, the application interface 100 is an icon on a client device, and the user simply drags a link to the search result over the icon. The user can then add appropriate descriptors, such as relevance to a certain group, to the result, and submit it to the cloud application 20 where it will be stored in the group database 80 for future reference during searches. Thus when another user performs a search using the cloud application 20, and identifies that particular group as a search criteria, the search engine 50 will pull the relevant search result from the group database 80 and the filter module 110 will identify the result as a match to the group criteria.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising the steps of:
receiving a user data set related to a user, the user being a member of a social network website hosted on a social network server having an associated social network database, the user being a member of at least one group of members of the social network website, the user data set including user defined search parameters;
storing the user data set in the social network database;
receiving, in a search engine, a search query from the user;
searching resources for results that are responsive to the search query;
identifying which of the responsive search results match the user defined search parameters contained in the user data set;
providing the responsive search results that match the user defined search parameters to the user;
receiving from the user a search result data set related to one or more of the responsive results provided to the user, the search results data set being associated with one or more of the at least one group of members of the social network website of which the user is a member;
storing the search result data set in the social network database.

2. The method of claim 1, wherein the resources include the social network database.

3. The method of claim 2, wherein user defined search parameters include a group limitation such that of responsive search results from the social network database, only search results from the search results data set associated with one or more of the at least one group of members of the social network website of which the user is a member are identified.

4. The method of claim 1, wherein the search parameters include the desired duration of the search.

5. The method of claim 1, wherein the search parameters include the identification of resources from which the user wishes to be provided search results.

6. The method of claim 1, wherein the user data set further includes data representing topics of interest to the user.

7. The method of claim 6, wherein the search parameters include a permission to allow advertisements.

8. The method of claim 7, further comprising the steps of:
searching an advertisement database;
identifying matching advertisements stored in the advertisement database that match the data representing topics of interest to the user;
providing matching advertisements to the user with the responsive search results that match the user defined search parameters to the user.
